(19) United States
(12) Patent Application Publication
(10) Pub. No.: US 2022/0400173 A1
(43) Pub. Date: Dec. 15, 2022

(54) LOCATING A WEARABLE DEVICE CASE

(71) Applicant: Microsoft Technology Licensing, LLC, Redmond, WA (US)

(72) Inventors: Saakshi GANGWAL, Kirkland, WA (US); Ruben CABALLERO, San Jose, CA (US); Navid POULAD, San Jose, CA (US)

(73) Assignee: Microsoft Technology Licensing, LLC, Redmond, WA (US)

(21) Appl. No.: 17/346,643

(22) Filed: Jun. 14, 2021

(51) Int. Cl. H04M 1/72457; H04M 1/02; H04B 1/3888

(52) U.S. Cl. CPC H04M 1/72457; H04M 1/0264; H04B 1/3888; H04M 2250/52

(57) ABSTRACT

One example provides a computing system comprising a case and a wearable device associated with the case, wherein the case is configured to hold the wearable device, and a sensor is located on one of the case and the wearable device. The computing system further comprises a logic subsystem and a storage subsystem. The storage subsystem comprises instructions executable by the logic subsystem to operate the sensor on the one of the case and the wearable device to read an identifier located on the other of the case and the wearable device, compare the identifier with a stored identifier, and when the identifier does not match the stored identifier, then output an alert via an output device.

### BACKGROUND

Cases may be used for a wide variety of different computing devices. For example, laptop computers may be carried in over-the-shoulder or briefcase-style cases, while smart phones may be placed in protective cases to help prevent damage. Some smartphone cases may include integrated electronics, such as batteries to augment the capacity of batteries on a smartphone, and/or memory card slots to provide for additional data storage.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to functional cases for wearable devices. One example provides a computing system comprising a case and a wearable device associated with the case, wherein the case is configured to hold the wearable device, and a sensor is located on one of the case and the wearable device. The computing system further comprises a logic subsystem comprising one or more logic devices located on one or more of the case and the wearable device, and a storage subsystem comprising one or more storage devices located on one or more of the case and the wearable device. The storage subsystem comprises instructions executable by the logic subsystem to operate the sensor on the one of the case and the wearable device to read an identifier located on the other of the case and the wearable device, compare the identifier with a stored identifier, and when the identifier does not match the stored identifier, output an alert via an output device.

Another example provides a computing system comprising a case and a wearable device associated with the case, wherein the case is configured to hold the wearable device. The computing system further comprises a logic subsystem comprising one or more logic devices located on one or more of the case and the wearable device, and a storage subsystem comprising one or more storage devices located on one or more of the case and the wearable device. The storage subsystem comprises instructions executable by the logic subsystem to receive a user input requesting the case to output a signal to locate the case, and in response to the user input, output the signal via an output device.

### BRIEF DESCRIPTION OF THE DRAWINGS

FIG. 1 shows an example use scenario for a wearable device.

FIG. 2 shows a block diagram for an example computing system comprising a wearable device and a case.

FIG. 3 shows an example wearable device.

FIG. 4 shows an example case comprising light sources.

FIG. 5 shows an example case comprising an electronic paper device.

FIG. 6 shows a block diagram illustrating example circuitry on a wearable device and on a case for the wearable device.

FIG. 7 schematically shows an example wearable device positioned in an example case.

FIG. 8 shows a flow diagram illustrating an example method of determining whether a wearable device matches a case.

FIG. 9 shows a flow diagram illustrating an example method of outputting a signal via an output device on a case.

FIG. 10 shows a block diagram of an example computing system.

### DETAILED DESCRIPTION

A computing device and a case configured to hold the computing device may be configured to work together as a computing system. In such a system, the case may be associated with a specific wearable device. For example, a system comprising a head-mounted display (HMD) and a case may incorporate some computing and communication function capabilities into the carrying case for the HMD. As a more detailed example, a case for the HMD may include cellular communications hardware, and the HMD may connect to the Internet and/or telephone network via a Bluetooth or WiFi connection to the case, in combination with a connection of the case to the Internet or telephone network. In such an example, the case includes a user-specific SIM card. Further, a case for a wearable device also may include computer readable storage that can be accessed by the wearable device. As such, personal information may be stored on the case.

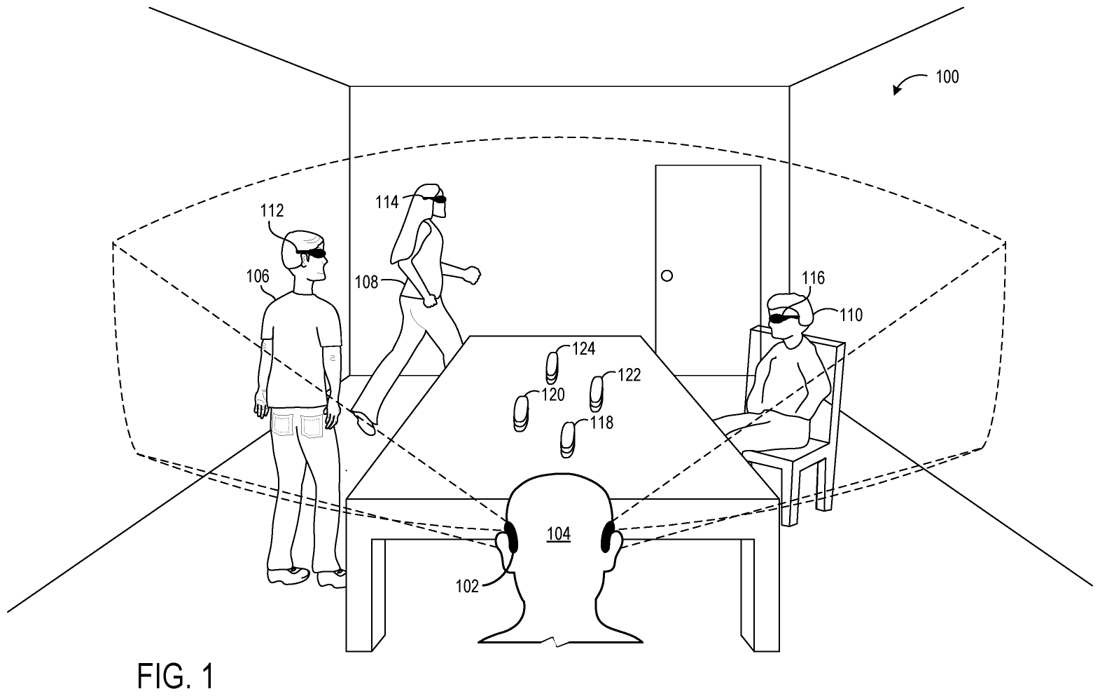

In some scenarios there may be a risk of a user mistaking another user's device case for their own. FIG. 1 shows an example use environment 100 comprising a conference room as viewed from the perspective of a user 102 wearing a wearable device 104, and in which users 106, 108, and 110 are respectively wearing wearable devices 112, 114, and 116. The users may use the devices for a virtual meeting, for example, and thus set their cases 118, 120, 122, and 124 aside temporarily. In such a setting, a user may accidentally pick up the wrong case when leaving. As a case may be associated with a particular HMD, this may cause inconvenience and potential loss of device functionality until the correct case is located.

Accordingly, examples are disclosed that relate to helping mitigate the risk of a user of a wearable device mistaking another case for their own case. For example, a case and/or a wearable device can be operated to output a signal in response to a user input to help the user to identify the case. As another example, a case and wearable device may share identification data when the wearable device is placed in the case. In such an example, if a user accidentally places a wearable device in the wrong case, the mismatch can be detected, and an alert may be output. As yet another example, a wearable device may be able to detect when a distance between the wearable device and the associated case is greater than a threshold distance, or to detect when a network connection between the wearable device and the case is otherwise lost, and alert the user.

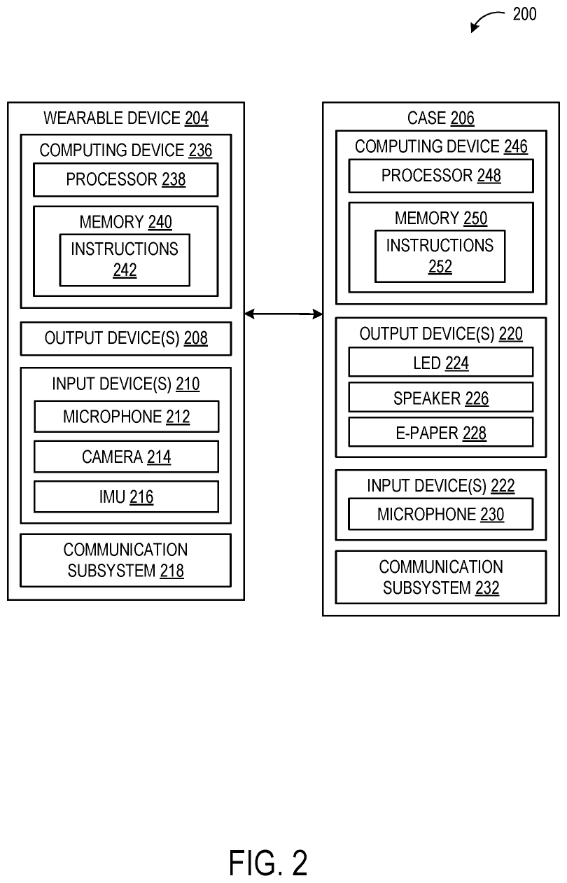

FIG. 2 shows a block diagram of an example system 200 including a wearable device 204 and a case 206 for the wearable device 204. The wearable device 204 includes one or more output device(s) 208 and one or more input device(s) 210. Example output devices include a see-through display system where the wearable device 204 is an HMD. Example input device(s) 210 include a microphone 212, a camera 214, and an inertial measurement unit (IMU) 216. The wearable device 204 further includes a communication subsystem 218 configured to communicate with the case 206 and potentially other computing devices, e.g. wirelessly via a network, or via a direct wired connection (e.g. when the wearable device 204 is placed in the case 206). The wearable device 204 and the case 206 may communicate using any suitable protocols, such as Bluetooth and/or WiFi, as examples, and may communicate directly or via a network link (e.g. a network access point, router, and/or other network device(s)).

The case 206 likewise includes one or more output device(s) 220, and also may include one or more input device(s) 222. Example output device(s) 220 include one or more light-emitting diodes (LED) 224, a speaker 226, and/or electronic paper 228, as examples. Example input device(s) 222 include a microphone 230. The case 206 further includes a communication subsystem 232 to communicate with the wearable device 204 and other computing devices.

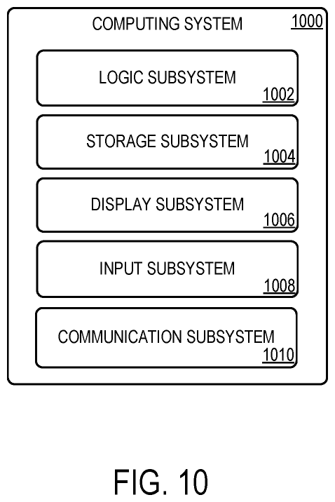

Each of the wearable device 204 and the case 206 includes a computing device 236, 246. Each computing device 236, 246 comprises a processor 238, 248 and a memory 240, 250 storing instructions 242, 252 that are executable by the respective processors 238, 248. For example, the instructions 242, 252 may be executable to receive a user input requesting the case and/or the wearable device to output a signal, such as a visual and/or auditory signal, and in response to the request output the signal. The instructions 242, 252 alternatively or additionally may be executable to communicate identification data between the case and the wearable device, and/or to operate a sensor on one of the case 206 or the wearable device 204 to read an identifier located on the other of the case or wearable device, compare the identifier with a stored identifier, and output an alert if the identifiers do not match. Additional aspects of computing devices 236, 246 are discussed in more detail below with reference to FIG. 10.

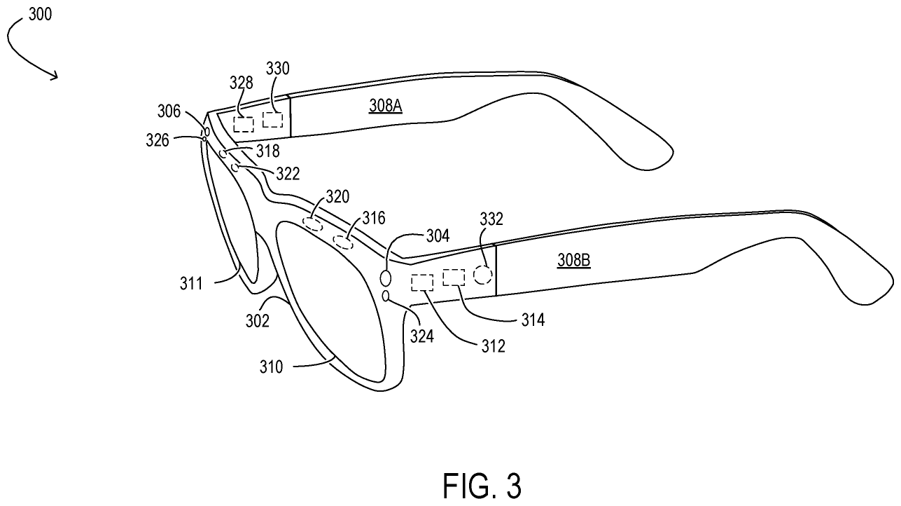

FIG. 3 shows an example wearable display device 300. The wearable display device 300 is an example of wearable device 102, 112, 114, 116, and 204. The wearable display device 300 includes a frame 302, a first camera 304, a second camera 306, a display, and temple pieces 308A, 308B. The wearable display device 300 comprises a first display 310 and a second display 311 supported by the frame 302, wherein each of the first display 310 and the second display 311 takes the form of a waveguide configured to deliver a projected image to a respective eye of a user. The first camera 304 and the second camera 306 in this example are located respectively at left and right sides of the frame 302, wherein each of the first camera and the second camera is located on the frame adjacent to an outer edge of the frame. The first camera 304 and second camera 306 are outward-facing cameras that may comprise head tracking cameras, environmental tracking cameras, or cameras generally configured to image surroundings of the wearable display device 300. The wearable display device 300 further includes an eye tracking system comprising a first eye tracking camera 316 and a second eye tracking camera 318, a face tracking system comprising a first face tracking camera 320 and a second face tracking camera 322, and a hand tracking system comprising a first hand tracking camera 324 and a second hand tracking camera 326. Data from the eye tracking system, the face tracking system, and/or the hand tracking system may be used to detect user inputs, and also may be used to help render displayed images in various examples.

The wearable display device 300 further comprises a first display module 312 positioned adjacent to the first camera 304 for displaying a first image of and a second display module 328 positioned adjacent to the second camera 306 for displaying a second image, where the first image and the second image combine to form a stereo image. Each display module may comprise any suitable display technology, such as a scanned beam projector, a microLED (light emitting diode) panel, a microOLED (organic light emitting diode) panel, or a LCoS (liquid crystal on silicon) panel, as examples. Further, various optics, such as the above-mentioned waveguides, one or more lenses, prisms, and/or other optical elements may be used to deliver displayed images to a user's eyes.

In addition to cameras, a wearable display device further may include other types of sensors. For example, the depicted wearable display device 300 comprises an inertial measurement unit system (IMU) comprising a first IMU 314 positioned adjacent to the first display module 312 and a second IMU 330 positioned adjacent to the second display module 328. The wearable device 300 also includes a microphone 332 for detecting audio inputs, such as user speech commands.

As mentioned above, some situations may pose a risk of a user of a wearable device taking a wrong case when leaving a setting where multiple wearable devices were in use. As such, a case may comprise instructions executable to output a signal in response to a user input requesting such an output. As one example, a user may input a speech command, such as “where is my case?” using a microphone on the wearable device or on the case. In examples where the case detects the speech command, the case may parse the speech input to identify the command, determine via speaker recognition whether the person who spoke the command is an owner or otherwise a recognized/authorized user of the case, and if so, automatically output a visual and/or auditory signal via an output device. Each other case that receives the command may determine via speaker recognition that the person who spoke the command is not associated with that case, and not make an output in response. In examples where the command is made via the wearable device, the wearable device may send an instruction to the case to output a visual and/or auditory signal via an output device on the case. In other examples, a user may trigger the user input via the wearable device using a displayed user interface element, an actuatable button on the wearable device, a hand gesture detectable by a camera on the wearable device, or any other suitable input.

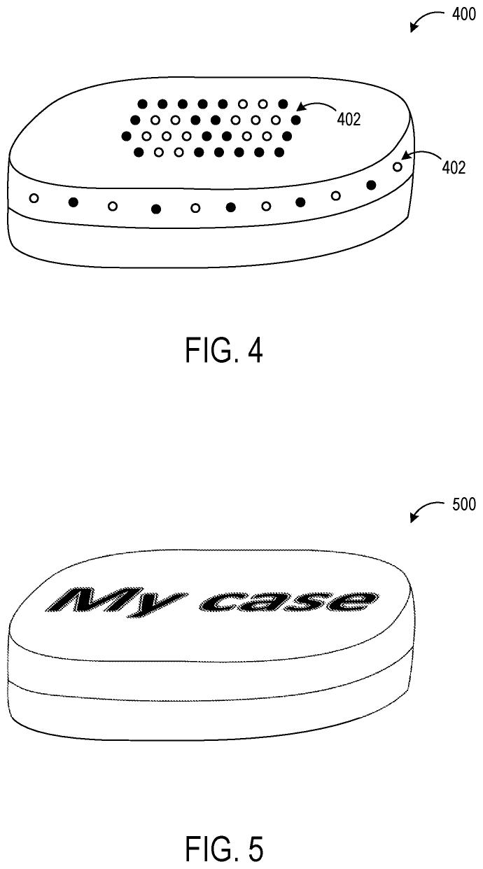

A case may output any suitable signal in response to such a user input. FIG. 4 schematically shows an example case 400 having a plurality of LEDs 402 (e.g. micro-LEDs) located on a side of the case 400 emitting light in an example arrangement. Light emitted from the case 400 may be static or be configured to vary in a pattern. In some examples, the light arrangement and/or pattern may be user-configured. In other examples, the light arrangement or pattern may be predetermined or randomized. In yet other examples, a single light source may be used (e.g. an LED incorporated into the case as a flashlight), and may output static light or a dynamic light pattern that varies in brightness and/or color. It will be understood that other suitable light sources besides LEDs also may be used.

As another example signal, FIG. 5 shows an example case 500 displaying a visual pattern via electronic paper on the case 500. Electronic paper (also referred to as electronic ink) is controllable to reflect light, rather than emit light via a light source. The electronic paper may be controlled to display pre-selected or user-configured words, images, symbols, or other suitable patterns. In other examples, any other suitable visual outputs may be used. Further, in some examples, a case may include a speaker or haptic device. In such an example, the case may output a sound and/or vibration, in addition to or alternatively to a visual output.

In addition to the case outputting a signal to help a user locate the case, in some examples a wearable device may be configured to output a signal to help locate an associated case. For example, the wearable device may track a location of the case using depth sensing (e.g. via a stereo camera arrangement, such as the above-described head-tracking cameras, or a direct measurement depth sensor, such as a time of flight camera), may determine an approximate location of the case based on communications with the case (e.g. via a network address of a WiFi device to which the case is connected), or may image a pattern on the case using a camera on the wearable device (e.g. an IR reflective barcode) when the case is in a current field of view. The wearable device then may display an indicator pointing out where the case is located (where the case is in a current field of view), a directional indicator that indicates a direction in which the case is located (where the case is nearby but not in a current field of view), a pin indicating the location of the case on a displayed map of an area (where the case is not nearby), and/or may make any other suitable output.

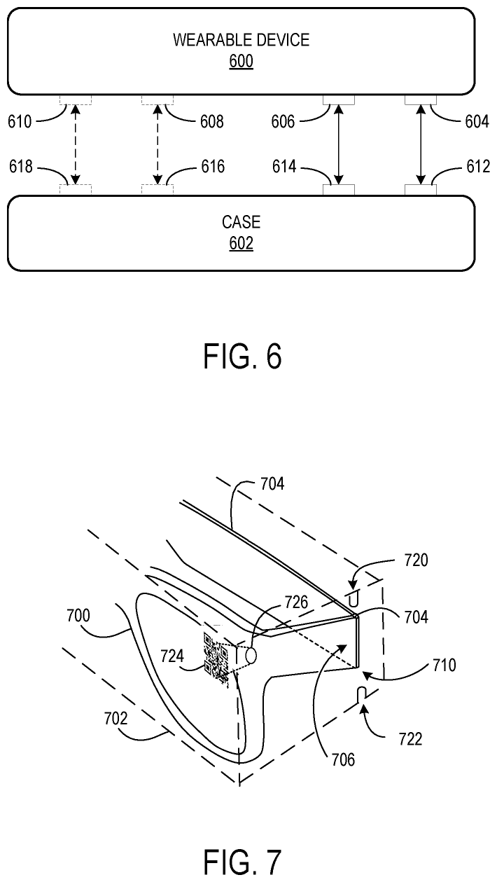

In some situations with multiple users of wearable devices, a user may place their wearable device in another user's case by accident. Thus, in some examples, to alert a user to this error, a wearable device and/or case may be configured to check for device/case mismatch when the wearable device is inserted into the case, and to output an alert when mismatch is detected. Any suitable mechanism may be used to detect such mismatch. As one example, electrical contacts between the wearable device and the case may be used to exchange identification data between the two to help determine a match or mismatch. FIG. 6 shows a block diagram of another example computing system comprising a wearable device 600 and a case 602, where the wearable device 600 is positioned within the case 602. The wearable device 600 comprises a first contact 604 and a second contact 606, and may optionally comprise one or more additional contacts (two of which are shown here as third contact 608 and fourth contact 610). The case 602 comprises a first case contact 612 and a second case contact 614 and further optionally comprises a third case contact 616 and a fourth case contact 618, wherein the first, second, third, and fourth case contacts are each positioned to interface with the respective first, second, third, and fourth contacts on the wearable device 600 when the wearable device 600 is positioned in the case 602. Each connection between corresponding contacts can be configured to transfer electrical power and/or data between the wearable device 600 and the case 602. In the examples comprising four contacts and four case contacts, the first, second, third, and fourth contacts and the first, second, third, and fourth case contacts may further be configured to enable USB communication between the wearable device 600 and the case 602.

The data transferred between the wearable device 600 and the case 602 via corresponding contacts may include identification data, and the computing system (e.g. via a computing device on the case and/or a computing device on the wearable device) may include instructions executable to compare the identification data. If the identification data for the wearable device 600 does not match the identification data for the case 602, the computing system may output an alert via an output device on the case 602 and/or the wearable device 600. Any suitable output may be used, including but not limited to a visual and/or an auditory output.

Such an exchange of identification data may occur when it is detected that a wearable device is placed into a case. FIG. 7 shows one example of case contacts positioned in a case 702 to automatically connect to contacts on a wearable device 700 positioned in the case 702. In this example, wearable device 700 comprises a first contact 704 arranged on a top side of a hinge 706 and a second contact 710 arranged on a bottom side of the hinge 706. Further, case 702 comprises a first case contact 720 and a second case contact 722 positioned respectively adjacent to first contact 704 and second contact 710 to make electrical contact between corresponding contacts when the wearable device 700 is positioned within the case. Upon electrical contact between corresponding contacts, the wearable device 700 and the case 702 may automatically exchange identification data to determine if a matching wearable device has been placed within the case. It will be understood that the configuration of contacts in FIG. 7 is shown for the purpose of example, and that any other suitable arrangement of electrical contacts positioned at any other suitable location in the case and on a wearable device may be used.

As another example of determining whether a case and wearable device are mismatched, a sensor on one of the case and the wearable device may be configured to read an identifier located on the other of the case and wearable device. FIG. 7 further shows an example identifier 724 in the form of an optical code positioned on the inside of the case 702. A camera 726 on the wearable device 700 may be configured to read the identifier 724 on the case 702, and the wearable device 700 may compare the identifier with a stored identifier. When the read identifier 724 does not match the stored identifier, either the wearable device 700 or the case 702 may be configured to output an alert, e.g. via a visual output device, an auditory output device, and/or other suitable output device. The camera 726 on the wearable device may be operated when the wearable device is detected as placed in the case, such as when the electrical contacts are made between the corresponding contacts on the case 702 and the wearable device 700. In other examples, an identifier may be positioned on the wearable device, and a camera inside the case may image the identifier on the wearable device.

In yet other examples, a wearable device may detect when a distance between the wearable device and its associated case is greater than a threshold distance (e.g. by tracking a location of the case via depth imaging using a stereo camera arrangement or other suitable depth sensor on the wearable device), and/or detect when a network connection between the wearable device and the case is lost, and alert the user via an output device on the wearable device. This may help to prevent a user from separating the wearable device from its case by a distance greater than a threshold distance. The wearable device may be further configured to store a last known location associated with the case, e.g. based on where a signal to the case was most recently lost, such that a user may be informed of a likely location for the case if the case is lost.

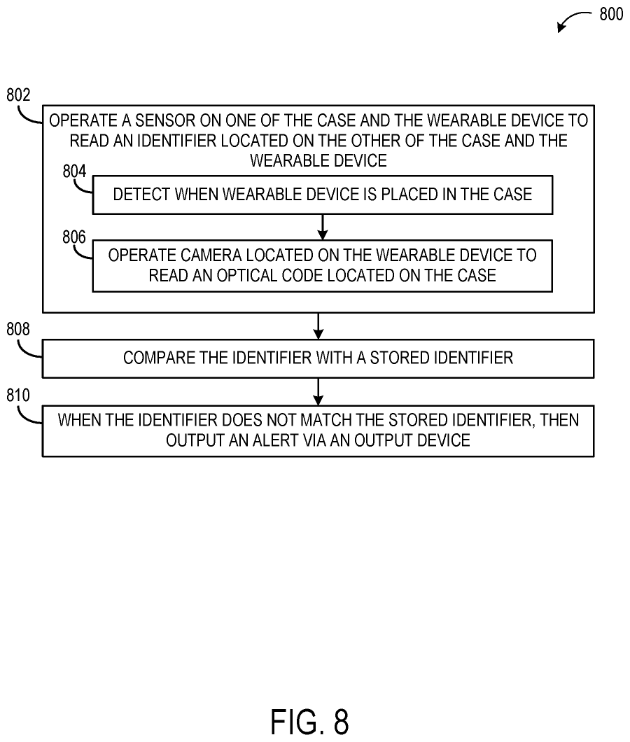

FIG. 8 shows an example method 800 of determining whether a wearable device matches a case. Method 800 includes, at 802, operating a sensor on one of the case and the wearable device to read an identifier located on the other of the case and the wearable device. This may include, at 804, detecting when the wearable device is placed in the case, for example, by communicating identification data between the case and the wearable device via electrical contacts between the case and wearable device. An identifier also may be read by operating a camera located on the wearable device to read an optical code located on the case, as indicated at 806. Method 800 further includes, at 808, comparing the identifier with a stored identifier, and at 810, when the identifier does not match the stored identifier, then outputting an alert via one or more output devices (e.g. via a visual output device and/or an audio output device).

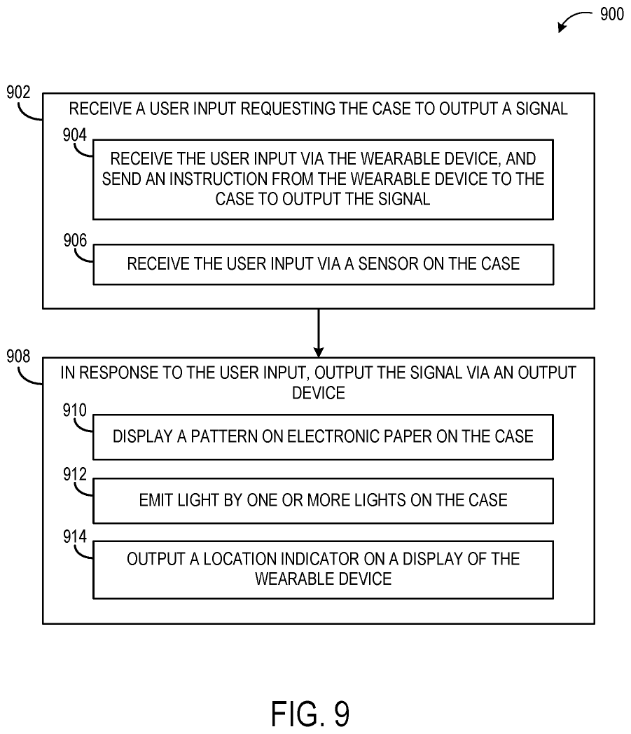

FIG. 9 shows an example method 900 of outputting a signal to help a user locate the case. Method 900 includes, at 902, receiving a user input requesting an output of a signal to help locate the case. In some examples, the user input may be received via the wearable device, and the wearable device may send an instruction to the case to output the signal, at 904. As mentioned above, any suitable user input may be used. Examples include speech inputs, gesture inputs (e.g. as detected by a hand tracking system of a wearable device), and hardware inputs (e.g. a press of a button on the wearable device). In other examples, the user input may be received via a sensor on the case, at 906. For example, a microphone on the case may receive a user voice input. Method 900 further includes, at 908, in response to the user input, outputting the signal. In some examples, the signal may be output via an output device on the case. In some such examples, outputting the signal may include, at 910, displaying a visual pattern on the case via electronic paper, and/or at 912, emitting light by one or more lights on the case (e.g. via LED(s)). Other signals that can be output by the case include audio and haptic signals. In further examples, as indicate at 914, a location indicator may be output via a display of the wearable device. As described above, various methods can be used by a wearable device to track or determine a location of the case, including but not limited to optical tracking (e.g. via a camera, such as a depth sensing system) and/or WiFi positioning, and the location indicator may vary in form depending upon whether the case is in a field of view, outside of a field of view but nearby, or not nearby.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

The logic subsystem 1002 includes one or more physical devices configured to execute instructions. For example, the logic subsystem 1002 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 1002 may include one or more processors configured to execute software instructions. Additionally or alternatively, the logic subsystem 1002 may include one or more hardware or firmware logic machines configured to execute hardware or firmware instructions. Processors of the logic subsystem 1002 may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

The storage subsystem 1004 includes one or more physical devices configured to hold instructions executable by the logic machine to implement the methods and processes described herein. When such methods and processes are implemented, the state of the storage subsystem 1004 may be transformed—e.g., to hold different data.

The storage subsystem 1004 may include removable and/or built-in devices. The storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage subsystem 1004 may include volatile, nonvolatile, dynamic, static, read/write, read-only, random-access, sequential-access, location-addressable, file-addressable, and/or content-addressable devices.

It will be appreciated that the storage subsystem 1004 includes one or more physical devices. However, aspects of the instructions described herein alternatively may be propagated by a communication medium (e.g., an electromagnetic signal, an optical signal, etc.) that is not held by a physical device for a finite duration.

Aspects of the logic subsystem 1002 and the storage subsystem 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1006 may be used to present a visual representation of data held by the storage subsystem 1004. This visual representation may take the form of a graphical user interface (GUI). As the herein described methods and processes change the data held by the storage subsystem 1004, and thus transform the state of the storage machine, the state of display subsystem 1006 may likewise be transformed to visually represent changes in the underlying data. The display subsystem 1006 may include one or more display devices utilizing virtually any type of technology. Such display devices may be combined with the logic subsystem 1002 and/or the storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

Another example provides a computing system comprising a case and a wearable device associated with the case, the case configured to hold the wearable device, a sensor located on one of the case and the wearable device, a logic subsystem comprising one or more logic devices located on one or more of the case and the wearable device, and a storage subsystem comprising one or more storage devices located on one or more of the case and the wearable device, the storage subsystem comprising instructions executable by the logic subsystem to operate the sensor on the one of the case and the wearable device to read an identifier located on the other of the case and the wearable device, compare the identifier with a stored identifier, and when the identifier does not match the stored identifier, then output an alert via an output device. The sensor may additionally or alternatively be located on the wearable device and comprises a camera, and wherein the identifier is read from an optical code located on the case. The instructions may additionally or alternatively be executable to operate the camera of the wearable device when the wearable device is detected as placed in the case. The output device may additionally or alternatively be located on the case. The output device may additionally or alternatively include a visual output device. The output device may additionally or alternatively include an audio output device. The output device may additionally or alternatively be on the wearable device. Circuitry in the case may additionally or alternatively be configured to form an electrical connection with circuitry in the wearable device when the wearable device is positioned in the case, and the instructions may additionally or alternatively be executable to communicate identification data between the case and the wearable device via the electrical connection.

Another example provides a computing system, comprising a case and a wearable device associated with the case, the case configured to hold the wearable device, a logic subsystem comprising one or more logic devices located on one or more of the case and the wearable device, and a storage subsystem comprising one or more storage devices located on one or more of the case and the wearable device, the storage subsystem comprising instructions executable by the logic subsystem to receive a user input requesting output of a signal to locate the case, and in response to the user input, output the signal via an output device of the computing system. The instructions may additionally or alternatively be executable to receive the user input via the wearable device, and wherein the wearable device is configured to send an instruction to the case to output the signal. The instructions may additionally or alternatively be executable to receive the user input via a sensor on the case. The sensor on the case may additionally or alternatively include a microphone. The signal may additionally or alternatively include an emission of light by one or more lights on the case. The signal may additionally or alternatively include a pattern displayed via an electronic paper device on the case. The signal may additionally or alternatively be user-configured.

Another example provides, on a case configured to hold a wearable device associated with the case, a method comprising receiving a user input requesting an output of a signal indicating a location of the case, the user input received on one or more of the wearable device and the case, and in response to the user input, outputting the signal. Receiving the user input may additionally or alternatively include receiving the user input via a microphone on the case. Receiving the user input may additionally or alternatively receiving an instruction from the wearable device via a wireless network. Outputting the signal may additionally or alternatively include one or more of displaying a visual pattern on the case and outputting an auditory signal from the case. Outputting the signal may additionally or alternatively include outputting a location indicator on a display of the wearable device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a case and a wearable device associated with the case, the case configured to hold the wearable device;
a sensor located on one of the case and the wearable device;
a logic subsystem comprising one or more logic devices located on one or more of the case and the wearable device; and
a storage subsystem comprising one or more storage devices located on one or more of the case and the wearable device, the storage subsystem comprising instructions executable by the logic subsystem to
operate the sensor on the one of the case and the wearable device to read an identifier located on the other of the case and the wearable device,
compare the identifier with a stored identifier, and
when the identifier does not match the stored identifier, then output an alert via an output device.

2. The computing system of claim 1, wherein the sensor is located on the wearable device and comprises a camera, and wherein the identifier is read from an optical code located on the case.

3. The computing system of claim 2, wherein the instructions are further executable to operate the camera of the wearable device when the wearable device is detected as placed in the case.

4. The computing system of claim 1, wherein the output device is located on the case.

5. The computing system of claim 4, wherein the output device comprises a visual output device.

6. The computing system of claim 4, wherein the output device comprises an audio output device.

7. The computing system of claim 1, wherein the output device is on the wearable device.

8. The computing system of claim 1, wherein circuitry in the case is configured to form an electrical connection with circuitry in the wearable device when the wearable device is positioned in the case, and wherein the instructions are executable to communicate identification data between the case and the wearable device via the electrical connection.

9. A computing system, comprising:
a case and a wearable device associated with the case, the case configured to hold the wearable device;
a logic subsystem comprising one or more logic devices located on one or more of the case and the wearable device; and
a storage subsystem comprising one or more storage devices located on one or more of the case and the wearable device, the storage subsystem comprising instructions executable by the logic subsystem to
receive a user input requesting output of a signal to locate the case, and
in response to the user input, output the signal via an output device of the computing system.

10. The computing system of claim 9, wherein the instructions are executable to receive the user input via the wearable device, and wherein the wearable device is configured to send an instruction to the case to output the signal.

11. The computing system of claim 9, wherein the instructions are executable to receive the user input via a sensor on the case.

12. The computing system of claim 11, wherein the sensor on the case comprises a microphone.

13. The computing system of claim 9, wherein the signal comprises an emission of light by one or more lights on the case.

14. The computing system of claim 9, wherein the signal comprises a pattern displayed via an electronic paper device on the case.

15. The computing system of claim 9, wherein the signal is user-configured.

16. On a case configured to hold a wearable device associated with the case, a method comprising:
receiving a user input requesting an output of a signal indicating a location of the case, the user input received on one or more of the wearable device and the case, and in response to the user input, outputting the signal.

17. The method of claim 16, wherein receiving the user input comprises receiving the user input via a microphone on the case.

18. The method of claim 16, wherein receiving the user input comprises receiving an instruction from the wearable device via a wireless network.

19. The method of claim 16, wherein outputting the signal comprises one or more of displaying a visual pattern on the case and outputting an auditory signal from the case.

20. The method of claim 16, wherein outputting the signal comprises outputting a location indicator on a display of the wearable device.
